(19) United States
(12) Patent Application Publication
(10) Pub. No.: US 2025/0092654 A1
(43) Pub. Date: Mar. 20, 2025

(54) GATE VALVE

(71) Applicant: Kohler Co,, Kohler, WI (US)

(72) Inventor: Tony L. Lambert, Sheboygan, WI (US)

(21) Appl. No.: 18/826,069

(22) Filed: Sep. 5, 2024

Related U.S. Application Data
(60) Provisional application No. 63/539,315, filed on Sep. 19, 2023.

(51) Int. Cl. E03D 1/32; E03D 1/34; E03D 5/10; F16K 31/06

(52) U.S. Cl. CPC E03D 1/32; E03D 1/34; E03D 5/10; F16K 31/0644

(57) ABSTRACT

A gate valve for a toilet includes a channel configured to conduct a flow of fluid, a flapper disposed in the channel and movable between an open position and a closed position in which the flapper blocks the channel, and a biasing member configured to bias the flapper toward a closed position.

### CROSS-REFERENCE TO RELATED APPLICATION

This application claims priority benefit of Provisional Application No. 63/539,315 (Docket No. 10222-23058A) filed on Sep. 19, 2023, which is hereby incorporated by reference in its entirety.

### FIELD

The present disclosure relates generally to toilets. More specifically, the present disclosure relates to gate valves for improved performance of toilets.

### BACKGROUND

Generally, toilets including in-line pressure flush engines require high in-line water pressure to operate. In-line pressure flush engines receiving water under insufficient pressure may operate poorly, failing to adequately remove waste from and rinse the bowl. Many buildings (e.g., commercial, residential) may not receive water under sufficient in-line pressure for in-line pressure flush engines to operate reliably. Accordingly, there is a need for gate valves and in-line flush engines including gate valves capable of reliably flushing under lower in-line pressure.

### BRIEF DESCRIPTION OF THE DRAWINGS

Objects, features, and advantages of the present disclosure should become more apparent upon reading the following detailed description in conjunction with the drawing figures, in which:

FIG. 1 illustrates a perspective view of a toilet in accordance with one example of the present disclosure.

FIG. 2 illustrates a gate valve in accordance with one example of the present disclosure.

FIG. 3 illustrates a gate valve in accordance with one example of the present disclosure.

FIG. 4 illustrates a toilet in accordance with one example of the present disclosure.

FIG. 5 illustrates a toilet in accordance with one example of the present disclosure.

FIG. 6 illustrates a toilet in accordance with one example of the present disclosure.

FIG. 7 illustrates a flow chart for flushing a toilet in accordance with one example of the present disclosure.

FIG. 8 illustrates a flow chart for charging a battery in accordance with one example of the present disclosure.

FIG. 9 illustrates an apparatus in accordance with one example of the present disclosure.

The figures illustrate certain exemplary embodiments of the present disclosure in detail. It should be understood that the present disclosure is not limited to the details and methodology set forth in the detailed description or illustrated in the figures. It should be understood that the terminology used herein is for the purposes of description only and should not be regarded as limiting.

### DETAILED DESCRIPTION

Described herein are devices, systems, and methods for flushing in-line toilets. Specifically, described herein are gate valves, flush engines including gate valves, and methods of flushing toilets including gate valves. The gate valves described herein may advantageously allow the bowl of a toilet to be pre-primed or filled with water prior to a flush or operations cycle of the toilet. Toilets including a gate valve in accordance with the present disclosure may advantageously be configured to use less water. Additionally, toilets including a gate valve as described herein are not affected by changes in in-line pressure allowing them to be reliably flushed under low in-line pressure.

For example, the toilets of this application improve how a siphon is created or induced, such as by pre-priming the siphon before each flush cycle is activated. Referring generally to the Figures, a gate valve in accordance with the present disclosure may include a channel configured to conduct a flow of water, a flapper disposed within the channel movable between an open position and a closed position, and a biasing member configured to bias the flapper toward a closed position, for example, applying a force to the flapper toward a closed position of the flapper. When the flapper is in the closed position, the flapper may block the channel preventing water from flowing through the channel and pre-priming a siphon by allowing the trapway and bowl to fill with water. The gate valve may then be moved to an open position, for example, when a flush cycle is initiated, and a siphon may be induced.

The toilets disclosed in this application include a passageway (e.g., trapway) with a valve (e.g., gate valve) located proximate to an outlet (e.g., drain or soil pipe) of the passageway for pre-priming the system. As used herein, the term “pre-prime” denotes that the water is introduced into the passageway in advance of (e.g., prior to, before, etc.) activation of a flush cycle, as opposed to “priming” which is performed after activation (e.g., initiation) of a flush cycle. Thus, the systems disclosed herein hold the pre-primed water in the passageway and bowl and, therefore, remain primed while the system is idle (i.e., between flush cycles). When the toilet is used (e.g., activated, flushed, etc.) and the system is actuated, a series of functions will initiate. According to an exemplary embodiment, actuating a flush cycle triggers water to flow from the rim or one or more rim jets for a predetermined amount of time, the valve in the passageway opens (e.g., after the predetermined amount of time), the mixture of waste and water is expelled from the system, then the valve closes, and the system refills the bowl and pre-primes the passageway with a volume of water for the next flush cycle.

In accordance with some examples of the present disclosure, the gate valve includes a biasing member, for example, a spring configured to apply a first force to the flapper toward a closed position of the flapper, biasing the flapper toward a closed position. Further, the contents (e.g., a volume of water) in the trapway and the bowl may apply a second force to the flapper toward an open position of the flapper, biasing the flapper toward an open position. Accordingly, when a magnitude of the second force exceeds a magnitude of the first force, the flapper may move to an open position. Thus, the biasing member included in a gate valve in accordance with the present disclosure may be selected such that the flapper moves to an open position when a predetermined volume of water and/or waste exceeds a predetermined threshold, preventing a toilet from overflowing.

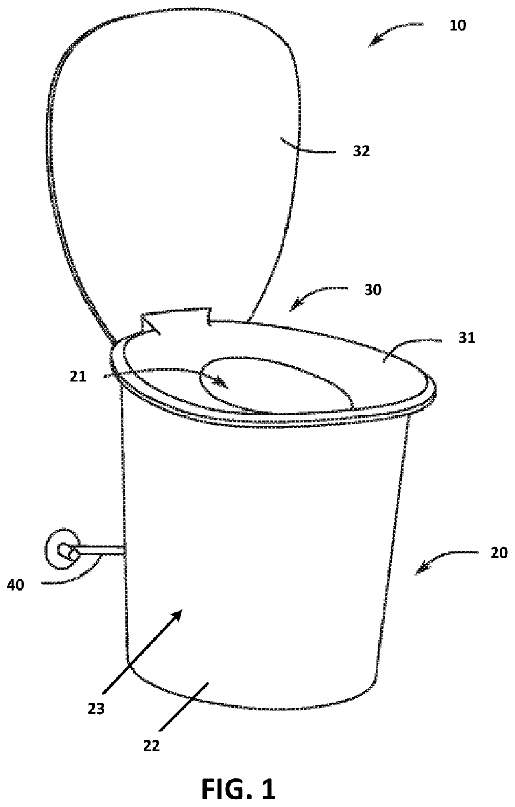

FIG. 1 illustrates a toilet 10 in accordance with one example of the present disclosure. Specifically, FIG. 1 illustrates an in-line toilet 10 including a pedestal or base 20 and a seat assembly 30. The toilet 10 includes an actuator that is configured to initiate an operational cycle when activated. The actuator may be a button configured to activate when depressed (or pulled) a predetermined distance or when touched, or any suitable device configured to activate based upon an input manipulation by a user. In some examples, an operational cycle may be initiated using one or more control signals sent wirelessly (e.g., via the internet) from a computer (e.g., cell phone) to the toilet 10.

It should be noted that the shapes and configurations of the base 20, seat assembly 30, and the internal components (including the trapway and other features) may vary from the embodiments shown and described herein, and that the embodiments disclosed herein are not intended as limitations. It should be noted that various components of the toilet may be made of a vitreous material such as clay. It should be noted that various components of the toilet may be polymeric and/or over molded or otherwise fixed to the toilet. The toilet disclosed herein may have a wide variety of skirted toilet configurations, and all such configurations are intended to be encompassed herein. The following description of various toilet features is therefore intended as illustration only of one possible embodiment, and it should be understood by those reviewing the present description that similar concepts or features may be included in various other embodiments.

The base 20 of the toilet 10 may include a wall 23 having any suitable shape that is configured to form a bowl 21 having an opening formed by an upper rim at the top of the opening. The base 20 may also be configured to include a plurality of walls having varying shapes that together form a bowl having an opening formed by a rim. The wall 23 of the pedestal may extend downward and/or rearward from the bowl 21 to form a lower portion 22 configured to support the base 20 and the toilet 10. The lower portion 22 may be formed by the end (e.g., lower rim) of the wall 23, or may include a member that extends generally in a horizontal plane from one or more than one end of the wall 23.

The base 20 may also include a top member that extends between two sides of the wall 23 (or between two opposing walls) and is provided rearward (or behind) the bowl 21, wherein the top member forms a plateau for supporting the seat assembly 30. For example, the top member may include one or more than one opening, wherein each opening is configured to receive a fastening device (e.g., bolt, screw, etc.) to couple (e.g., attach) the seat assembly 30 to the top member of the base 20. As another example, the top member may include one or more than one fastening device (e.g., bolts, recessed nuts, etc.) integrally formed therein (i.e., already provided connected or coupled to the base 20), wherein the fastening device may be used to couple or secure at least a portion of the seat assembly 30 to the base 20. The seat assembly 30 may include a hinge, hinge shoulders configured to receive a fastener, a seat coupled to the hinge and a cover coupled to the hinge.

The bowl 21 of the base 20 may be configured to include a receptacle (e.g., sump) and an outlet opening, wherein the water and waste is collected in the receptacle until being removed through the outlet opening, such as upon activation of the actuator. The base 20 may also include a base internal passageway, such as a trapway, that connects the outlet opening or discharge outlet of the bowl 21 to a drain or soil pipe. The passageway, or trapway, generally includes a first portion, a second portion, and a weir separating the first and second portions. The first portion of the passageway may extend from the outlet opening of the bowl 21 at an upwardly oblique angle to the weir. The second portion of the passageway may extend from the weir downwardly to the exiting device, such as the drain or soil pipe.

Between operational cycles (e.g., flush cycles) of the toilet 10, the water (and waste) is collected in the first portion of the trapway (in addition to the receptacle of the bowl), such that the weir prohibits the water from passing past the weir and into the second portion of the trapway. A flushing cycle may begin upon activation of the actuator. Upon activation of the actuator, a gate valve may be opened and additional water (e.g., from an in-line water supply 40) may be discharged into the bowl 21 of the base 20, resulting in the flushing action and waste removal through the soil pipe. For example, water may be discharged into the bowl from one or more rim outlets located in or below a rim of the toilet and/or a sump jet disposed in a sump (e.g., first part of the trapway) of the toilet. The flushing cycle may include generation of a siphon to assist the flushing action and waste removal.

The seat assembly 30 may include a cover member 32 (e.g., lid), a seat member 31 (e.g., ring member), and a hinge. The seat member 31 may be configured to include an annular member that encircles an opening, wherein the annular member provides a seating surface for the user of the toilet 10. The seat member 31 may also be pivotally coupled (e.g., attached) to the hinge, wherein the seat member may rotate (or pivot) about the hinge, such as between a first lowered or seated position and a second raised or upright position. The cover member 32 may be configured to be round, oval, or any other suitable shape. Typically, the profile or shape of the outer surface of the cover member will be configured to match (i.e., to be substantially similar) to the profile of the outer surface of the seat member to improve the aesthetics of the seat assembly and toilet. The cover member 32 may also be coupled to the hinge, wherein the cover member may rotate (or pivot) about the hinge, such as between a first lowered or down position and a second raised or upright position. The cover member 32 may be provided above the seat member in the down position to thereby cover the opening of the seat member 31, as well as to conceal the inside of the bowl 21 of the base 20. The cover member 32 may be configured to be disposed in an upright position, such that the cover member 32 remains in the upright position in order for a user to sit upon the seat member 31.

According to some examples, the toilet 10 may be comprised of two or more materials. For example, the toilet 10 may include a flush engine including the bowl 21 and/or the trapway of the toilet 10 and shroud configured to cover (e.g., hide, conceal) the flush engine. According to some examples, the flush engine may be comprised of a first material, or a first class of materials and the shroud may be comprised of a second, different material or class of materials. According to some examples, the flush engine (e.g., bowl and/or trapway) may be comprised of a vitreous material and the shroud may be comprised of a plastic and/or metal material.

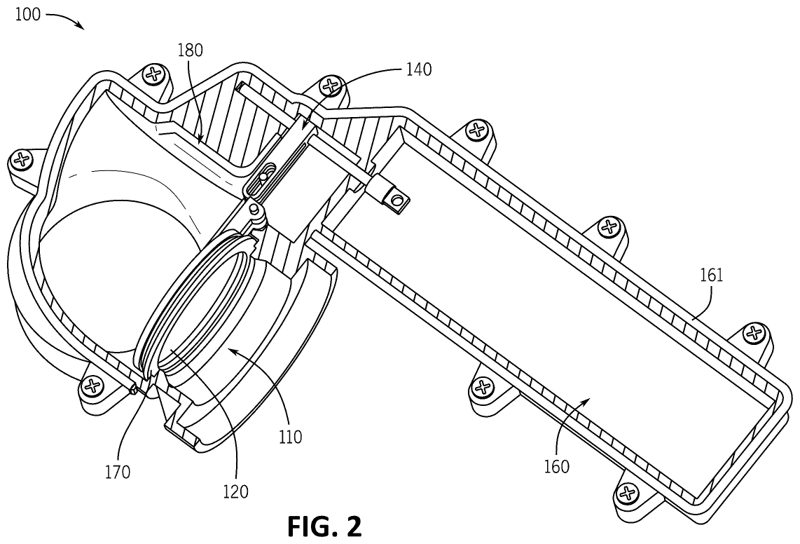

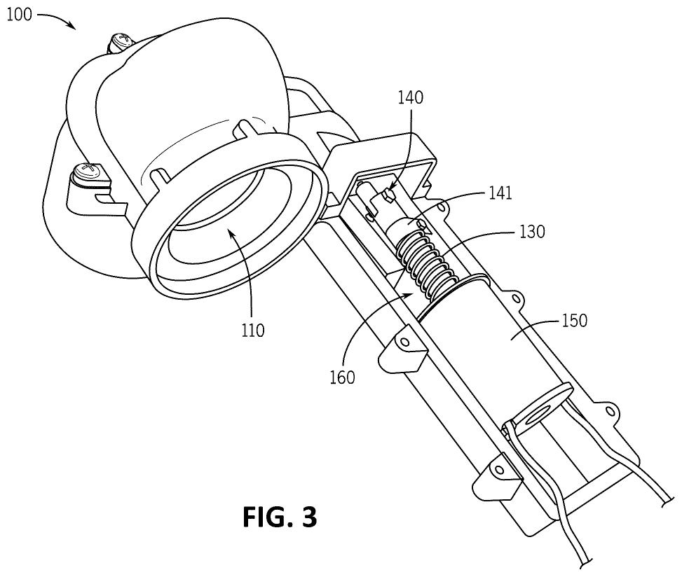

Referring generally to FIGS. 2 and 3, a gate valve 100 in accordance with one example of the present disclosure is illustrated. The gate valve 100 includes a channel 110, a flapper 120, and a biasing member 130. In some examples, the gate valve 100 may further include a linkage system 140, a solenoid 150, and a dry cavity 160.

The channel 110 may be configured to conduct or convey a flow of fluid. Specifically, the channel 110 of the gate valve 100 may be connected to installed in line with a passageway or trapway of a toilet and may be configured to convey water and/or waste from a bowl or sump of the toilet to an exiting device such as a drain pipe or soil pipe of the toilet.

The flapper 120 is disposed within the channel 110 and may be configured to move between an open position and a closed position. In some examples, as illustrated in FIGS. 2 and 3, the flapper 120 may be configured to rotate between the open and closed positions. In other examples, the flapper 120 may be configured to translate (e.g., linearly) between the open and closed positions. As illustrated in FIG. 2, when the flapper 120 is in the closed position, the flapper 120 may block the channel 110 preventing water and/or waste from flowing through the channel 110. In some examples, the flapper 120 may include a seal 170 configured to engage a surface (e.g., inner surface) of the channel 110 when the flapper 120 is in the closed position. In the open position, the flapper 120 may not block the channel 110 and water and/or waste may be allowed to flow from the bowl or trapway through the channel 110 passed the flapper 120 and to an exiting device. In some examples, the gate valve 100 may include one or more recesses 180 configured to accommodate the flapper 120 when the flapper 120 is in the open position.

Referring to FIG. 3, the gate valve 100 may further include a biasing member 130 configured to apply a force or bias the flapper 120 toward a closed position. In some examples, as illustrated in FIG. 3, the biasing member may be a spring (e.g., metallic spring). In other examples, the biasing member may be a rubber spring, a rubber band, a gas spring (e.g., pneumatic cylinder), a magnet, of the like.

In some examples, as illustrated in FIG. 3, the biasing member 130 may be disposed between a linkage system 140 and a solenoid 150. Specifically, as illustrated in FIG. 3, in some examples, the biasing member 130 may be disposed between the solenoid 150 and a protrusion or ring 141 disposed along the linkage system 140. The biasing member 130 may apply a force to the linkage system 140 (and the flapper via the linkage system 140) toward a closed position of the flapper 120. Specifically, in some examples, the biasing member may be compressed between the solenoid 150 and the linkage system 140 such that biasing member 130 exerts a linear force away from the solenoid 150 on the linkage system 140. The linear force applied to the linkage system 140 away from the solenoid may correspond or move the flapper 120 toward a closed position.

The linkage system 140 may extend between the solenoid 150 and the flapper 120. The linkage system 140 may be configured to transmit or apply a force from the biasing member 130 and/or the solenoid 150 to the flapper 120. Specifically, when the solenoid 150 is not activated (e.g., inactive) the biasing member 130 may exert a force on the linkage system 140 away from the solenoid 150 and the linkage system 140 may transfer the force to the flapper 120 biasing the flapper 120 toward a closed position. In some situations, the force applied to the flapper 120 by the biasing member 130 (e.g., via the linkage system 140) may move the flapper 120 from an open position to a closed position. In other situations, the force applied to the flapper 120 by the biasing member 130 (e.g., via the linkage system 140) may maintain the flapper 120 in the closed position (e.g., when the flapper 120 is already in the closed position).

The solenoid 150 may be coupled to the linkage system 140 and may be configured to actuate applying a force to the linkage system 140. Specifically, in some examples, the solenoid 150 may be configured to actuate pulling the linkage system 140 toward the solenoid 150. As the solenoid 150 actuates, the solenoid 150 may apply a force to the linkage system 140 and the flapper 120 (e.g., vial the linkage system 140). The force applied by the solenoid 150 may cause the linkage system 140 and the flapper 120 to move (e.g., from a closed position to an open position). As the linkage system 140 and/or flapper 120 move (e.g., from a closed position to an open position) the biasing member 130 may be compressed between the linkage system 140 and the solenoid 150.

In some examples, the biasing member 130 may operate as an overflow protection device. Specifically, a magnitude of a first force applied by the biasing member 130 on the flapper 120 (e.g., via the linkage system 140) toward a closed position may be controlled by changing a spring constant and/or magnitude of compression of the biasing member 130. Accordingly, a biasing member 130 may be selected such that the flapper 120 is configured to move from a closed position to an open position when the weight of a volume and/or mass of water and/or waste in the bowl and trapway exerts a second force (e.g., normal force) on the flapper 120, toward an open position of the flapper 120, exceeding the first force. Accordingly, a biasing member may be selected such that a predetermined threshold (e.g., volume, weight) of water and waste causes the flapper 120 to move from the closed position to an open position, preventing the toilet from overflowing.

Referring generally to FIGS. 2 and 3, in some examples the gate valve 100 may include a dry cavity 160. In some examples, the biasing member 130 and/or the solenoid 150 may be disposed within the dry cavity 160. In some examples, the linkage system 140 may extend into the dry cavity 160. The dry cavity 160 may be water tight and/or waterproof and may be configured to keep the biasing member 130, solenoid 150, and/or linkage system 140 dry. In some examples, the dry cavity 160 may include a cavity seal 161 extending around the dry cavity 160 configured to prevent water from entering the dry cavity 160.

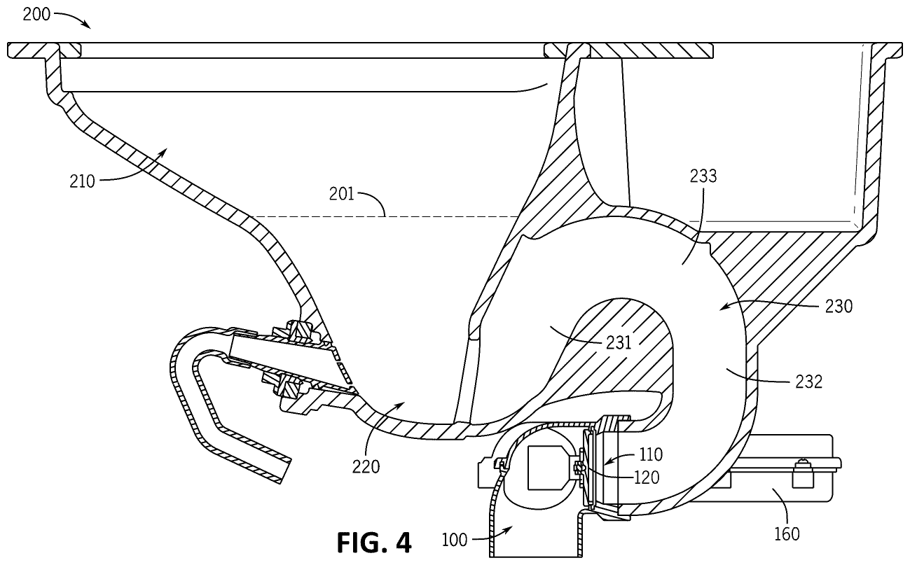

Referring to FIG. 4, a toilet 200 in accordance with one example of the present disclosure is illustrated. As shown in FIG. 4, the toilet 200 includes a bowl 210, sump 220, and trapway 230. The bowl 210 may be in communication with and/or include the sump 220 disposed at a bottom of the bowl 210. As described above with respect to FIG. 1, the sump 220 or receptacle may hold water and/or waste during an operational cycle of the toilet 200. The sump 220 may be in communication the trapway 230. As noted above with respect to FIG. 1, the trapway 230 may include a first portion 231, second portion 232, and a weir 233 separating the first and second portions 231,232. As illustrated in FIG. 4, the first portion 231 may extend from the sump 220 at an upwardly oblique angle to the weir 233. The second portion 232 of the weir 233 downwardly to an exiting device such as drain pipe or soil pipe.

As illustrated in FIG. 4, the toilet 200 includes a gate valve 100 disposed in or coupled to the trapway 230 of the toilet 200. In some examples, as illustrated in FIG. 4, the gate valve 100 may disposed in the second portion 232 of the trapway 230. The gate valve 100 may be coupled to the trapway 230 such that the channel 110 of the gate valve 100 is in communication with the trapway 230.

Referring to FIG. 4, the toilet 200 is illustrated in a primed or pre-primed state in which the flapper 120 of the gate valve 100 is closed and the bowl 210 and trapway 230 of the toilet 200 are filled with a predetermined volume of water. In some examples, a water level 201 of the toilet 200 may be at the same level (e.g., vertically) as a top of the trapway 230 when the toilet is in a pre-primed. A water level 201 of the toilet 200 in a pre-primed state may vary.

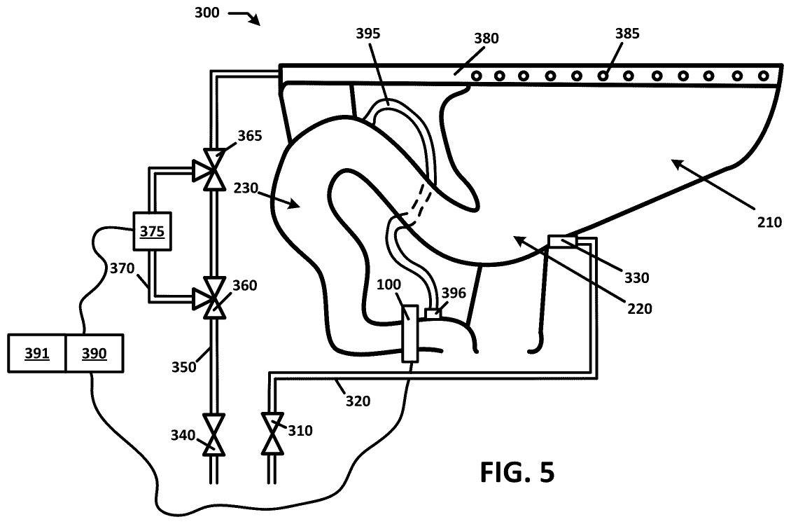

Referring to FIG. 5, a toilet 300 in accordance with another example of the present disclosure is illustrated. As shown in FIG. 5, the toilet 300 may include a bowl 210, a sump 220, a trapway 230, and a gate valve 100. The bowl 210, sump 220, and trapway 230 may be the same as those discussed above with respect to FIG. 4. As illustrated in FIG. 5, the toilet 300 may further include a sump jet valve 310, a sump jet line 320, a sump jet outlet 330, a rim valve 340, a rim line 350, a first diverter valve 360, a recharging line 370, a hydraulic turbine 375, a second diverter valve 365, a rim channel 380, and rim outlets 385. In some examples, the toilet 300 may further include a controller 390 and a battery 391.

The sump jet valve 310 may be configured to control a flow of fluid (e.g., water) from a water supply (e.g., a building water supply) to a sump jet line 320. The sump jet line 320 may be a conduit (e.g., pipe, tube, house) configured to conduct or convey a flow of water from the sump jet valve 310 to a sump jet outlet 330. The sump jet outlet 330 may be disposed in the sump 220 of the toilet 200 and may be configured to provide water to the sump 220 during a flush or operational cycle of the toilet 200.

The rim valve 340 may be configured to control a flow of fluid (e.g., water) from a water supply (e.g., building water supply) to a rim line 350. The rim line 350 may be a conduit (e.g., pipe, tube, hose) configured to conduct or convey a flow of water from the rim valve 340 to a rim channel 380 of the toilet 200. The rim channel 380 may be disposed in or below a rim of the toilet 200 and may be in communication with one or more rim outlets 385 disposed between the rim channel 380 and the bowl 210. During a flush or operational cycle of the toilet 300, fluid (e.g., water) may flow through the rim valve 340 into the rim line 350, through the rim line 350 into the rim channel 380, through the rim channel 380 into the rim outlets 385, and through the rim outlets 385 into the bowl 210. Water provided to the bowl 210 may be used to rinse the walls of the bowl 210 and/or fill the bowl 210 and trapway 230 with water. In some examples, each of the sump jet valve 310 and the rim valve 340 may be solenoid valves configured to actuate (e.g., open, close) in response to receipt of one or more control signals and/or electric current. In some examples, the sump jet valve 310 and the rim valve 340 may actuate concurrently during a flush or operational cycle. In other examples, the sump jet valve 310 and the rim valve 340 may actuate at different times during an operational cycle of the toilet 300.

Still referring to FIG. 5, in some examples, the toilet 300 may further include a first diverter valve 360, a recharging line 370, a hydraulic turbine 375, and a second diverter valve 365. The first and second diverter valves 360, 365 may be configured to selectively divert a flow of fluid (e.g., water) from the rim line 350 to a recharging line 370. As illustrated in FIG. 5, the recharging line 370 may be in communication with the rim line 350 via the first and second diverter valves 360, 365. Specifically, the first diverter valve 360 may be configured to selectively divert a flow of fluid from the rim line 350 to the recharging line 370. When the first diverter valve 360 diverts the flow of fluid to the recharging line3 370, the second diverter valve 365 may prevent back flow in the rim line (e.g., flow toward rim valve 340). When the first diverter valve 360 is not diverting a flow of fluid to the recharging line 370, the second diverter valve 365 may prevent fluid from flowing into the recharging line 370. In some examples, the first diverter valve 360 and the second diverter valve 365 may be solenoid valves configured to actuate, for example, opening and closing to selectively divert a flow of water in response to receipt of one or more control signals and/or electric current.

The recharging line 370 may include a hydraulic turbine 375 configured to generate power (i.e., electric current) as fluid flows through the recharging line 370 passed the hydraulic turbine 375. Specifically, the hydraulic turbine 375 may include an impeller disposed in a pathway of water flowing through the recharging line 370. As fluid flows through the recharging line 370 it may contact the impeller, rotating the impeller. The hydraulic turbine 375 may further include one or more magnets and one or more coils configured to generate power as fluid flows passed the impeller, rotating the impeller.

The hydraulic turbine 375 may be connected (e.g., electrically) to a controller 390 and/or battery 391 included in the toilet 300. The battery 391 may be configured to store power generated by the hydraulic turbine 375. Additionally, the battery 391 may be configured to provide stored power to one or more components of the toilet 300. For examples, the battery 391 may be connected to the solenoid 150 of the gate valve 100 and may be configured to provide power to the solenoid 150. In some examples, the battery may be connected to and configured to provide power to the sump jet valve 310 and the rim valve 340.

The controller 390 may be connected to (e.g., electrically) and/or in communication with the hydraulic turbine 375, the solenoid 150 of the gate valve 100, the first diverter valve 360, and/or the second diverter valve 365. In some examples, the controller 390 may power generated by the hydraulic turbine 375. The controller 390 may be configured to selectively provide power (e.g., electric current) and/or control signals to the solenoid 150 of the gate valve 100, the first diverter valve 360, and/or the second diverter valve 365. For example, the controller 390 may be configured to selectively provide power and/or one or more control signals to the solenoid causing to solenoid 150 to actuate (e.g., moving the flapper 120 to an open position). Additionally, the controller 390 may selectively provide power and/or control signals to the first and second diverter valves 360, 365 causing the first and second diverter valves to actuate, for example, opening and/or closing so as to divert a flow of fluid to the recharging line 370 or maintain a flow of water in the rim line 350. Additionally, in some examples, the controller 390 may be connected to and/or in communication with the sump jet valve 310 and the rim valve 340. For example, the controller 390 may selectively provide current and/or control signals to the sump jet valve 310 and the rim valve 340 opening and/or closing the sump jet valve 310 and/or the rim valve 340 (e.g., controlling a flow into the sump jet line 320 and/or the rim line 350, respectively).

In some examples, the toilet 300 may be configured to perform a recharging cycle or operation in which the rim valve 340 is open such that water is provided to the rim line 350. During the recharge cycle the first diverter valve 360 is configured to divert the flow of water into the recharging line 370. In some examples, the entire flow of water through the rim line 350 may be diverted to the recharging line 370. In other examples, only a portion of the water flowing through the rim line 350 may be diverted to the recharging line 370. As water flows through the recharging line 370 it may flow through the hydraulic turbine 375 contacting an impeller, causing the impeller to rotate and power (e.g., electric current) to be generated. During the recharge cycle, the power generated by the hydraulic turbine 375 may be provided to the battery 391 charging the battery 391.

The flow of water diverted (e.g., provided) to the recharging line 370 may flow through the second diverter valve 365 back into the rim line 350 and through the rim channel 380 to the one or more rim outlets and into the bowl 210. The solenoid 150 may actuate during the recharge cycle, opening the flapper 120 such that water provided to the bowl via the one or more rim outlets may flow through the toilet to a drain or soil pipe. In some examples, the sump jet valve 310 may remain closed during the recharge cycle. In other examples, the sump jet valve 310 may be open and water may be provided to the sump 220 via the sump jet outlet 330 during the recharge cycle.

In some examples, the controller 390 may be configured to initiate a recharging cycle at a preset time and/or after a predetermined interval of time. Specifically, the controller 390 may be configured to initiate a recharge cycle one or more times during each day such that the battery 391 may be recharged with power generated by the hydraulic turbine 375. In some examples, controller 390 may initiate a recharge cycle after 24 or more hours. The controller 390 may be configured to initiate the recharge cycle for a period to time at which it is not likely that a user will use the toilet 300, for example, during the night.

Referring generally to FIG. 5, in some examples, the recharging line 370, hydraulic turbine 375, controller 390, and the battery 391 described above may be included in the gate valve 100. For example, the gate valve 100 may include a housing and the recharging line 370, hydraulic turbine 375, controller 390, and battery 391 may be disposed within the housing of the gate valve 100. In these examples, the recharging line 370 included in the housing of the gate valve 100 may be connected to a rim line 350 of the toilet via first and second diverter valves 360, 365.

In some examples, the toilet 300 may further include a vent channel 395 extending between extending from and inlet disposed at a top of the trapway 230 to an outlet disposed downstream of the gate valve 100. The vent channel 395 may further include a vent channel valve 396 configured to selectively allow a flow of fluid, for example, water and/or air to flow through the vent channel 395. In some examples, the vent channel valve 396 may be a solenoid valve. The vent channel 395 may be configured to vent air from the trapway 230 upstream of the gate valve 100 to downstream of the gate valve 100 when the gate valve 100 is closed, allowing a portion of the trapway 230 upstream of the gate valve to be filled (e.g., pre-primed) with water. In addition to venting the trapway 230, the vent channel 395 may provide overflow protection when the gate valve 100 is closed. Specifically, water in the trapway may flow into the inlet of the vent channel 395 disposed at a top of the trapway 230 when a water level in the toilet (e.g., the bowl 210) is above the inlet of the vent channel 395. Water flowing into the vent channel 395 may flow to the outlet, downstream of the gate valve 100, preventing the toilet 300 from overflowing. In some examples, the vent channel valve 396 may be open when the gate valve 100 is closed allowing the vent channel 395 to vent air downstream of the gate valve 100 and providing overflow protection. In some examples, the vent channel valve 396 may be closed when the gate valve 100 is open.

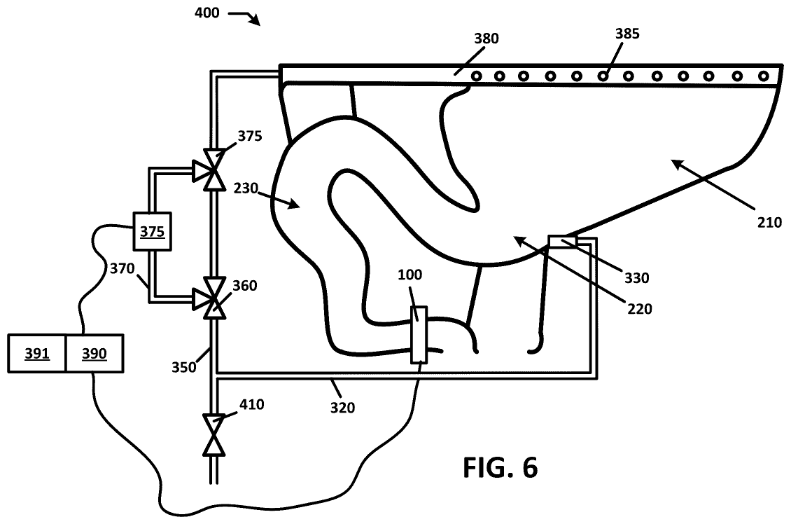

Referring to FIG. 6, a toilet 400 in accordance with another example of the present disclosure is illustrated. The toilet 400 may be substantially similar to the toilet 300 of FIG. 5; however, instead of the sump jet valve 310 and the rim valve 340, the toilet 400 includes a single flush valve 410. The flush valve 410 may be configured to selectively provide a flow of fluid (e.g., water) to both the sump jet line 320 and the rim line 350. In some examples, the flush valve 410 may be a solenoid valve. In these examples, the flush valve 410 may be connected to and/or in communication with the controller 390 and may be configured to selectively receive power and/or one or more control signals from the controller actuating (e.g., opening, closing) the flush valve 410. In other examples, the flush valve 410 may be a mechanical valve. In these examples, the flush valve 410 may be configured to supply a flow of water to the sump jet line 320 and the rim line 350 for a predetermined period of time after being actuated.

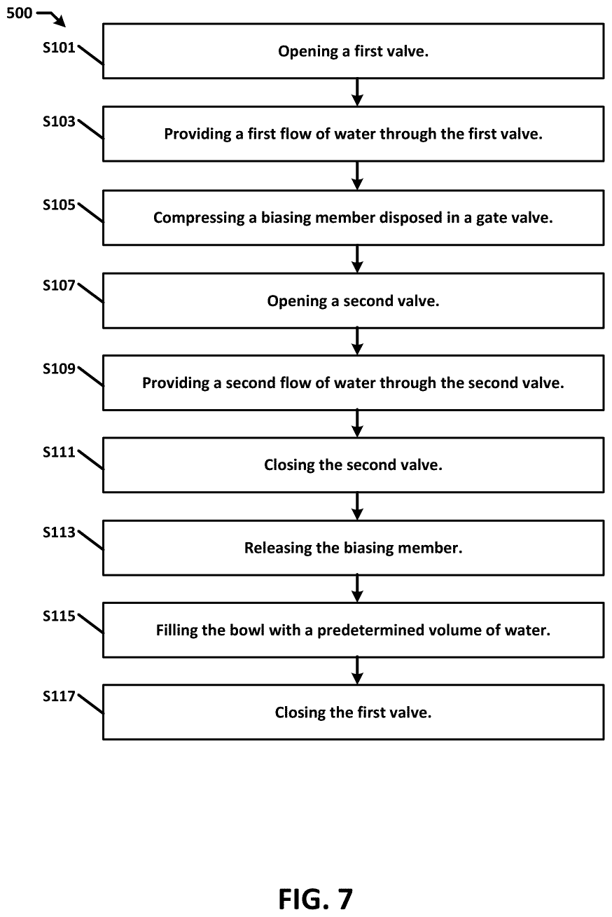

Referring to FIG. 7, a flow chart 500 for an operational or flushing cycle of a toilet in accordance with one example of the present disclosure is illustrated. The flow chart 500 may be used with any of the gate valve 100 or the toilets 200, 300, 400 described herein. For ease of explanation, the flow chart 500 is described below with respect to the toilet 300 of FIG. 5. Additional, different, or fewer acts may be provided. The flow chart 500 may be implemented in the order shown but may also be implemented in or according to any number of different orders.

In a first act S101, a rim valve 340 (e.g., first valve) is opened. As described above, the rim valve 340 may be configured to selectively provide a flow of fluid (e.g., water) from a fluid supply to a rim line 350 of the toilet 300. In some examples, the rim valve 340 may be a solenoid valve opened in response to a control signal and/or electric current provided via the controller 390 and/or battery 391.

In a second act S103, a first flow of water is provided through the rim valve 340 (e.g., first valve), the first flow of water rinsing a bowl 210 of the toilet 300. As described above, a flow of water may be provided through the rim valve 340 to the rim line 350. The flow of water may travel through the rim line 350 into the rim channel 380 and out of the rim channel 380 into the bowl 210 through one or more rim outlets 385. The flow of water provided to the bowl 210 may flow through the rim outlets 385 into the bowl 210, rinsing the bowl 210.

In a third act S105, the biasing member 130 included in the gate valve 100 may be compressed, causing a flapper 120 to move from a closed position to an open position. In some examples, the biasing member 130 may be compressed between the solenoid 150 and the linkage system 140 (specifically, a ring 141 of the linkage system 140) as the solenoid 150 is actuated, pulling the linkage system 140 toward the solenoid 150. As the biasing member 130 is compressed, a force applied by the biasing member 130 on the linkage system 140 toward a closed position of the flapper 120 may be reduced. Additionally, as the solenoid actuates the linkage system 140 may move the flapper 120 from a closed position in which a channel 110 of the gate valve 100 is blocked to an open position in which the channel 110 is not blocked (e.g., a state in which water and/or waste may flow through the channel 110 passed the flapper 120).

In some examples, as the flapper 120 moves from closed position to an open position, water and/or waste disposed in the trapway 230 and the bowl 210 may begin flowing through the channel 110 in the gate valve 100 and a siphon may be induced.

In a fourth act S107, a sump jet valve 310 (e.g., second valve) is opened. As described above, the sump jet valve 310 may be configured to selectively provide a flow of fluid (e.g., water) from a fluid supply to a sump jet line 320. In some examples, the sump jet valve 310 may be a solenoid valve opened in response to a control signal and/or electric current provided via the controller 390 and/or battery 391.

In a fifth act S109, a second flow of water is provided through the sump jet valve 310 to the sump jet line 320. As described above, the second flow of water may travel through the sump jet line 320 to the sump jet outlet 330 and through the sump jet outlet 330 into a sump 220 of the toilet 300.

In a sixth act S111, the sump jet valve 310 (e.g., second valve) may be closed. In some examples, the sump jet valve may be closed in response to a control signal and/or electric current provided via the controller 390 and/or battery 391. In some examples, the controller 390 may be configured to close the sump jet valve 310 a predetermined period of time after the sump jet valve 310 is opened. The predetermined period of time may correspond to a desired or required volume of provided to the sump via the sump jet outlet 330.

In a seventh act S113, the biasing member 130 is released, causing the flapper 120 to move from the open position to the closed position. Specifically, in some examples, the solenoid 150 may actuate or stop pulling on the linkage system 140. When the solenoid 150 stops pulling on the linkage system 140, the biasing member 130 may extend or expand between the solenoid 150 and the linkage system 140 (e.g., specifically the ring 141), moving the linkage system 140 and the flapper 120 via the linkage system 140 to a closed position. In some examples, the solenoid 150 may actuate or stop pulling the linkage system in response to one or more control signals from the controller 390 and/or the battery 391 ceasing to provide power to the solenoid 150.

In an eighth act S115, the bowl 210 and/or the trapway 230 may be filled with a predetermined volume of water. Specifically, the bowl 210 and trapway 230 may be pre-primed as a volume of water accumulates in the bowl 210. Specifically, after the flapper 120 moves to the closed position, water provided to the bowl 210 through the one or more rim outlets 385 may accumulate in the trapway 230 and bowl 210 of the toilet 300. In some examples, the trapway 230 may be completely filled with water and/or the bowl 210 may be filled with water to an elevation corresponding to a top of the trapway 230 (as shown in FIG. 4), pre-priming the trapway 230 and bowl 210 for a subsequent flush or operational cycle.

In a ninth act S117, the rim valve 340 (e.g., first valve) may be closed. In some examples, the rim valve 340 may be closed in response to one or more control signals and/or power supplied to the rim valve 340 via the controller 390 and/or the battery 391. In some examples, the controller 390 may be configured to close the rim valve 340 a predetermined period of time after the gate valve 100 (e.g., flapper 120) is closed. The predetermined period of time may correspond to a desired or required volume of water to fill the trapway 230 and bowl 210, pre-priming (e.g., a siphon in) the toilet 300 for a subsequent operational cycle. According to some examples, the predetermined period of time may be a period of time required to completely fill the trapway 230 of the toilet 300 with water.

According to some examples, the trapway 230 and bowl 210 of the toilet 200 may be filled with a predetermined volume of water, priming a siphon in the toilet during act S103. Accordingly, a siphon may be primed in the toilet 300 at the beginning of a flush or operational cycle of the toilet 300, such that the trapway 230 of the toilet 300 is not filled with water between operational cycles of the toilet 300. According to some examples, during act S103, a flow of water may be provided through the rim valve 340 for a predetermined period of time before the biasing member is compressed in act S105. The predetermined period of time for which the rim valve 340 is open during act S103, before the biasing member is compressed in act S105 may correspond to a period of time required for the bowl 210 and trapway 230 to be filled with a predetermined volume of water, priming a siphon in the toilet 300. According to some examples, the predetermined volume of water may be a volume of water required to completely fill the trapway 230 of the toilet 300.

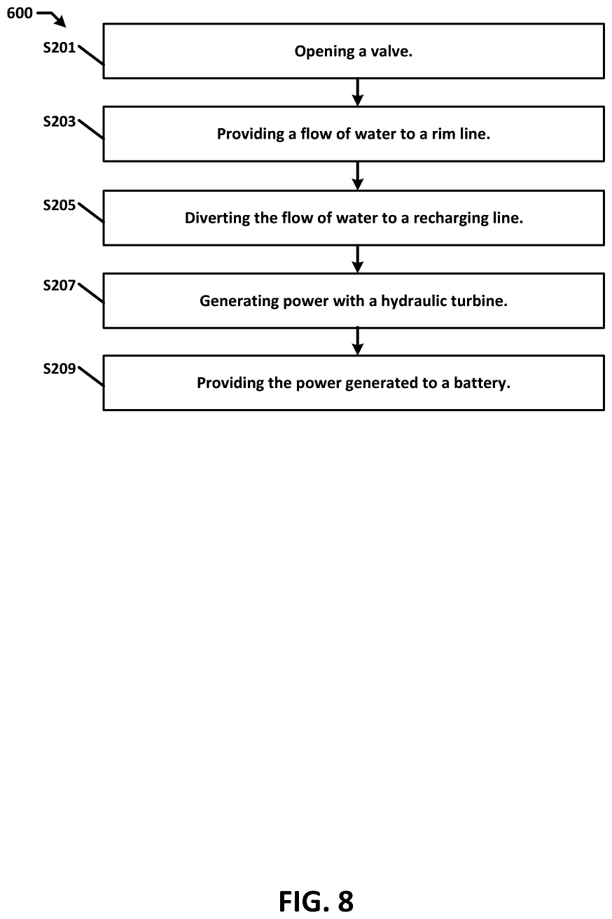

Referring to FIG. 8, a flow chart 600 for a charging cycle of a toilet in accordance with one example of the present disclosure is illustrated. The flow chart 600 may be used with any of the gate valve 100 and/or the toilet 200, 300, 400 described herein. For ease of explanation, the flow chart 600 is described below with respect to the toilet 300 of FIG. 5. Additional, different, or fewer acts may be provided. The flow chart 600 may be implemented in the order shown but may also be implemented in or according to any number of different orders.

In a first act S201, a rim valve 340 (e.g., valve) may be opened. As described above, the rim valve 340 may be configured to selectively provide a flow of fluid (e.g., water) from a fluid supply to a rim line 350 of the toilet 300. In some examples, the rim valve 340 may be a solenoid valve opened in response to a control signal and/or electric current provided via the controller 390 and/or battery 391.

In a second act S203, a flow of water is provided through the rim valve 340 (e.g., valve) into the rim line 350.

In a third act S205, the flow of water in the rim line 350 is diverted to the recharging line 370. Specifically, as described above, a first diverter valve 360 may divert the flow of water through the rim line 350 to the recharging line 370. In some examples, the first diverter valve 360 may actuate, diverting the flow of water to the recharging line in response to one or more control signals and/or power supplied to the first diverter valve 360 via the controller 390 and/or the battery 391.

In a fourth act S207, the hydraulic turbine 375 generates power. Specifically, as described above, as water flows through the recharging line 370 it may contact an impeller of the hydraulic turbine 375, rotating the impeller and causing the hydraulic turbine 375 to generate power.

In a fifth act S209, the power generated by the hydraulic turbine 375 may be provided to the battery 391. Specifically, the battery 391 may store the power generated by the hydraulic turbine to power the solenoid 150 and/or other components (e.g., sump jet valve 310, rim valve 340, first diverter valve 360, second diverter valve 365) of the toilet 300. In some examples, the battery 391 may provide power to the flush valve 410 of the toilet 400.

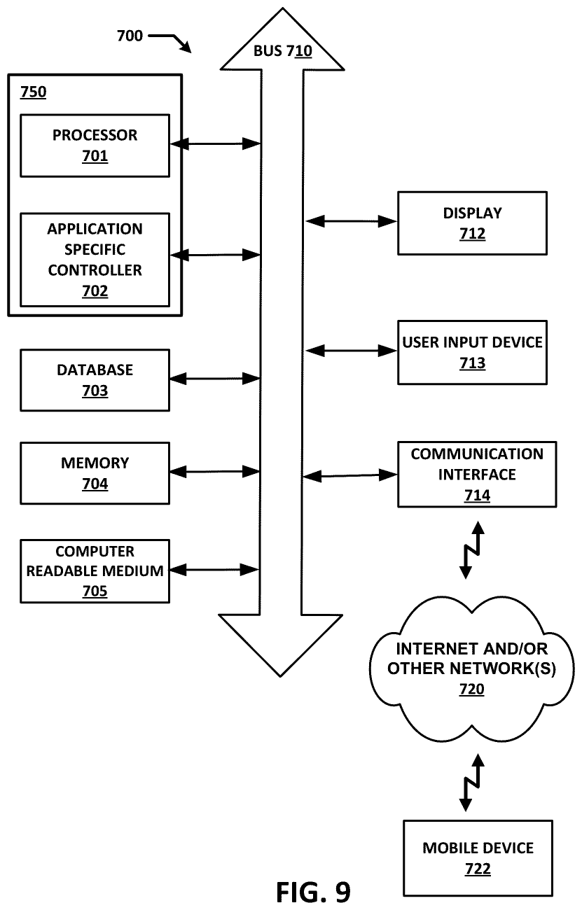

Referring to FIG. 9, an apparatus 700 for facilitating an operational (e.g., flush) cycle of a toilet (e.g., 200, 300, 400) in accordance with one example of the present disclosure is illustrated. In some examples, the apparatus 700 may be implemented as the controller 390 of the toilets 300, 400. The apparatus 700 includes a bus 710 facilitating communication between a controller 750 that may be implemented by a processor 701 and/or application specific controller 702 and one or more components including a database 703, a memory 704, a computer readable medium 705, display 712, a user input device 713, and a communication interface 714.

The contents of the database 703 may include one or more volumes of water for example, a volume of water to be provided to the bowl via a sump jet outlet 330, a volume of water provided to the bowl 210 via one or more rim outlets 385 during a flush or operational cycle, a volume of water dispensed from a sump jet outlet 330 during an operational cycle, and/or a volume of water required to fill the bowl 210 and trapway 230 (e.g., a volume of water provided to the bowl 210 after gate valve 100 is closed). In some examples, the database 703 may store an equation or equations for calculating a volume, flow rate, or time period relating to water dispensed and/or conveyed through the sump jet valve 310 and/or rim valve 340.

The memory 704 may be a volatile memory or a non-volatile memory. The memory 704 may include one or more read only memory (ROM), random access memory (RAM), a flash memory, an electronic erasable program read only memory (EEPROM), or other type of memory. The memory 704 may be removable from the apparatus 700, such as a secure digital (SD) memory card.

The memory 704 and/or the computer readable medium 705 may include a set of instructions that can be executed to cause the controller to perform any one or more of the methods or computer-based functions disclosed herein. For example, the controller 750 may send one or more controller signals and/or electric current to the sump jet valve 310, the rim valve 340, the solenoid 150, opening or closing the valves and/or actuating the solenoid 150 (i.e., such that the gate valve 100 and/or toilets 200, 300, 400 perform the flow charts 500 or 600). In some examples, the controller 750 may send one or more controller signals and/or electric current to the first diverter valve 360 and/or the second diverter valve 365 causing the toilet 200, 300, 400 to perform the flow chart 600.

A user may initiate an operational cycle, input one or more volumes, and/or input one or more time periods relevant to an operational cycle using the display 712 and/or user input device 713. The display 712 may comprise a screen and the user input device 713 may comprise one or more buttons on the apparatus 700. In some embodiments, the display 712 and user input device 713 may comprise a touch sensitive surface (i.e., a touch screen). In some examples, the user input device may be an actuator as described above with respect to FIG. 1.

The communication interface 714 may be connected to the network 720, which may be the internet. In some embodiments, the network 720 may be connected to one or more mobile devices 722. The one or more mobile devices may be configured to send a signal to the communication interface 714 via the network 720. For example, a more mobile devices may send a signal to the communication interface to initiate an operational cycle of the toilet 200, 300, 400 or change one or more volumes of water and/or time periods (e.g., predetermined time periods) associated with an operation cycle of the toilet.

The communication interface 714 may include any operable connection. An operable connection may be one in which signals, physical connections and/or logical communications may be sent and/or received. An operable connection may include a physical interface, an electrical interface, and/or a data interface. The communication interface 714 provides for wireless and/or wired communications in any known or later developed format.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A gate valve for a toilet, the gate valve comprising:
a channel configured to conduct a flow of fluid;
a flapper disposed within the channel and movable between an open position and a closed position in which the flapper blocks the channel, preventing fluid from flowing through the channel; and
a biasing member configured to bias the flapper toward the closed position.

2. The gate valve of claim 1, wherein the biasing member is configured to apply a first force to the flapper, biasing the flapper toward a closed position,
wherein contents of a toilet bowl are configured to apply a second force to the flapper, biasing the flapper toward an open position, and
wherein when a magnitude of the second force exceeds a magnitude of the first force, the flapper is configured to move to an open position.

3. The gate valve of claim 2, further comprising a solenoid configured to compress the biasing member, reducing the magnitude of the first force on the flapper.

4. The gate valve of claim 3, further comprising a dry cavity,
wherein the biasing member and the solenoid are disposed in the dry cavity.

5. The gate valve of claim 3, further comprising a linkage system extending between the solenoid and the flapper.

6. The gate valve of claim 3, further comprising:
a hydraulic turbine configured to generate power; and
a battery configured to store power generated by the hydraulic turbine,
wherein the battery is connected to the solenoid and configured to supply power to the solenoid.

7. The gate valve of claim 1, wherein the flapper is configured to rotate between the open position and the closed position.

8. The gate valve of claim 1, wherein the flapper is configured to translate between the open position and the closed position.

9. A toilet, the toilet comprising:
a bowl including a sump;
a trapway in fluid communication with sump; and
a gate valve including a flapper and a biasing member, the flapper configured to move between an open position and a closed position in which the flapper blocks a channel, preventing fluid from flowing through the channel, the biasing member configured to bias the flapper toward a closed position.

10. The toilet of claim 9, wherein the biasing member is configured to apply a first force to the flapper, biasing the flapper toward a closed position,
wherein contents of a toilet bowl are configured to apply a second force to the flapper, biasing the flapper toward an open position, and
wherein when a magnitude of the second force exceeds a magnitude of the first force, the flapper is configured to move to an open position.

11. The toilet of claim 10, wherein the gate valve further comprises:
a solenoid configured to compress the biasing member, reducing the magnitude of the first force on the flapper.

12. The toilet of claim 11, further comprising a dry cavity,
wherein the biasing member and the solenoid are disposed in the dry cavity.

13. The toilet of claim 11, further comprising:
a flush valve;
a rim line in communication with flush valve and configured to conduct a flow of fluid to a rim outlet;
a sump jet line in communication with the flush valve and configured to conduct a flow of fluid to a sump jet outlet; and
a bypass line including a hydraulic turbine, the bypass line in communication with the rim line via a first diverter and a second diverter.

14. The toilet of claim 13, further comprising:
a battery connected to the hydraulic turbine and the solenoid; and
a controller connected to the battery and the solenoid.

15. The toilet of claim 9, further comprising:
a sump jet valve configured to selectively provide a first flow of fluid to a sump jet line, the sump jet line configured to conduct the first flow of fluid to a sump jet outlet;
a rim valve configured to selectively provide a second flow of fluid to a rim line, the rim line configured to conduct the second flow of fluid to a rim outlet; and
a bypass line including a hydraulic turbine, the bypass line in communication with the rim line via a first diverter and a second diverter.

16. A method of flushing a toilet, the method comprising:
opening a first valve;
providing a first flow of water through the first valve, the first flow of water rinsing a bowl of the toilet;
compressing a biasing member disposed in a gate valve causing a flapper to move from a closed position to an open position;
opening a second valve;
providing a second flow of water through the second valve, the second flow of water flowing into a sump of the toilet;
closing the second valve;
releasing the biasing member causing the flapper to move form the open position to the closed position;
filling the bowl with a predetermined volume of water; and
closing the first valve.

17. The method of claim 16, wherein the compressing the biasing member disposed in the gate valve includes actuating a solenoid, compressing the biasing member.

18. The method of claim 17, wherein the releasing the biasing member includes actuating the solenoid, releasing the biasing member.

19. The method of claim 16, wherein the gate valve is disposed in a trapway of the toilet.

20. The method of claim 19, wherein the first flow of water provided through the first valve fills the trapway with a predetermined volume of water, priming a siphon in the toilet.
